(19) United States
(12) Patent Application Publication
(10) Pub. No.: US 2004/0153996 A1
(43) Pub. Date: Aug. 5, 2004

(54) Method and system for determining the defining classLoader of a Java class as it is being defined

(75) Inventors: James Russell Boykin, Pflugerville, TX (US); Alberto Giammaria, Austin, TX (US); Brian Joseph Schlosser, Austin, TX (US); Kevin Gary Tapperson, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, Armonk, NY

(21) Appl. No.: 10/355,530

(22) Filed: Jan. 30, 2003

(51) Int. Cl. G06F 9/44; G06F 9/45

(52) U.S. Cl. 717/118; 717/148; 717/166

(57) ABSTRACT

A technique is presented for determining the defining ClassLoader class of a Java class as it is being defined within a Java Virtual Machine (JVM) by instrumenting the “java.lang.ClassLoader” class. Within a JVM, all ClassLoader instances call one of the “defineClass” methods of class “java.lang.ClassLoader” in order to pass the raw bytes for loaded a class to the JVM to have it defined as a Java class. Therefore, instrumentation code is inserted into the “defineClass” methods of class “java.lang.ClassLoader”; the instrumentation code stores an identity of the defining ClassLoader prior to the invocation of the class load hook by the JVM, which can use the identity of the defining ClassLoader for various purposes.

### BACKGROUND OF THE INVENTION

1. Field of the Invention

The present invention relates to an improved data processing system and, in particular, to a method and apparatus for performing system management in a data processing system. Still more particularly, the present invention provides a method and apparatus for a software program development tool for managing the operation of software applications through software instrumentation.

2. Description of Related Art

A Java Virtual Machine (JVM) loads Java classes through instances of another Java class named “java.lang.ClassLoader”. The purpose of a ClassLoader is to provide a mechanism to retrieve or load the raw bytes representing a Java class and pass those raw bytes to the JVM to be defined as a Java class. In Java, once a class has been defined, a simple sequence of API calls can be made to determine which instance of “java.lang.ClassLoader” that was used to define the class. The ClassLoader instance that defines a Java class is referred to as the defining ClassLoader of the class. Being able to retrieve the defining ClassLoader for a Java class can be important as it can provide important contextual information about the class.

The JVM provides a hook that allows a Java class to be modified as it is being defined by the JVM. This hook is provided as part of the Java Virtual Machine Profiling Interface (JVMPI) and is named “JVMPI_EVENT_CLASS_LOAD_HOOK”, hereinafter termed the class load hook. The JVM invokes this hook after a ClassLoader has retrieved the raw bytes representing a Java class and passed those raw bytes to the JVM but prior to the definition of that class within the JVM. The hook can be used to make any modification desired to the raw bytes representing the Java class prior to its definition. The hook, however, does not provide a mechanism to determine the instance of “java.lang.ClassLoader” that was used to retrieve the raw bytes representing the Java class and which has subsequently passed those raw bytes to the JVM to be defined as a Java class.

Hence, a programmer that is attempting to use the class load hook along with knowledge of a defining ClassLoader is faced with a timing problem. As noted above, knowledge of the defining ClassLoader for a Java class can provide important contextual information about the class, and this contextual information could be useful during operations which are invoked through the class load hook. However, the defining ClassLoader cannot be determined until some time after the class load hook is invoked.

Therefore, it would be advantageous to provide a mechanism to determine the defining ClassLoader of a Java class as it is being defined by the JVM for use by operations invoked through the class load hook.

### SUMMARY OF THE INVENTION

A method, an apparatus, a system, and a computer program product are presented for determining the defining ClassLoader class of a Java class as it is being defined within a Java Virtual Machine (JVM). An identity of a class loader class that loads a class into a virtual machine is stored.

A routine that has been registered to be invoked for class load events after the identity of the class loader class has been stored; and

retrieving the stored identity of the class loader class in response to invoking the routine.

A2. The method of claim A1 further comprising:

using the stored identity of the class loader class to modify information associated with the class before the class is defined by the virtual machine.

A3. The method of claim A2 further comprising:

modifying class bytes for the class.

A4. The method of claim A3 further comprising:

instrumenting the class.

A5. The method of claim A2 further comprising:

defining the class by the virtual machine after information associated with the class is modified.

A6. The method of claim A1 wherein the storing step and the invoking step are performed before the class is defined by the virtual machine.

A7. The method of claim A1 wherein the storing step further comprises:

invoking an instrumented method within the class loader class, wherein the instrumented method is a “defineClass” method for the class loader class; and

saving the identity of the class loader class within an instrumented version of a native “defineClass0” method.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical network of data processing systems, each of which may implement the present invention;

FIG. 1B depicts a typical computer architecture that may be used within a data processing system in which the present invention may be implemented;

FIG. 2 depicts a block diagram that shows a typical JVM with some of the typical components for loading and defining a Java class;

FIG. 3 depicts a data flow diagram that shows a typical progression of a dataset representing a class as it passes through a series of processing stages;

FIG. 4 depicts a block diagram that shows a modified JVM that has been enhanced for performing additional operations during the loading and defining of a Java class;

FIG. 5 depicts a flowchart that shows a process within a typical JVM for using a JVMPI class load hook to modify the raw bytes of a recently loaded class before the class is formally defined by the JVM; and

FIG. 6 depicts a flowchart that shows a process within a JVM that has been instrumented in accordance with the present invention in order to obtain the defining ClassLoader for a recently loaded class such that the raw bytes of the recently loaded class can be modified by a JVMPI class load hook with reference to information about the defining ClassLoader.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

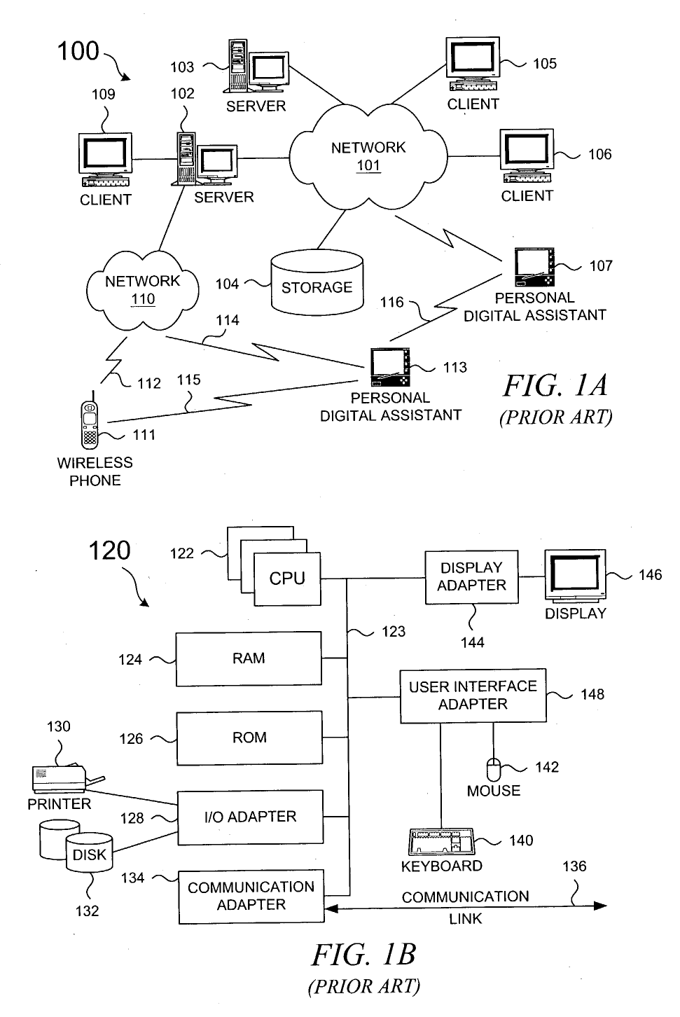

With reference now to the figures, FIG. 1A depicts a typical network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as LDAP (Lightweight Directory Access Protocol), TCP/IP (Transport Control Protocol/Internet Protocol), HTTP (HyperText Transport Protocol), etc.. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks or personal ad-hoc networks. In a similar manner, PDA 113 can transfer data to PDA 107 via wireless communication link 116.

The present invention could be implemented on a variety of hardware platforms and software environments. FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, extensible Markup Language (XML), HyperText Markup Language (HTML), Handheld Device Markup Language (HDML), Wireless Markup Language (WML), and various other formats and types of files. It should also be noted that the distributed data processing system shown in FIG. 1A is contemplated as being fully able to support a variety of peer-to-peer subnets and peer-to-peer services.

A preferred embodiment of the present invention is configured to operate in conjunction with Java applications and their associated runtime environments, but the present invention may be implemented in similar environments that provide the required functionality.

The Java language is an object-oriented programming language that is compiled to run on any Java Virtual Machine (JVM). Hence, as long as a given hardware device and its associated operating system support a version of a JVM, a Java application can be executed on a computer system with support from the JVM. Java programs are compiled into bytecode, which will run on any JVM. The JVM essentially acts as an interpreter between the Java bytecodes and the system on which the Java program is executing.

There are four major components to a JVM, all of which are implemented in software. The four components are the registers, the operand stack, the garbage collected heap, and the method area. The method area contains the method code, i.e. the compiled Java code, and symbol tables. The compiled Java code, i.e. the bytecode, consists of a set of instructions. Each instruction consists of a one byte opcode followed by any needed operands. Compiled Java programs are typically referred to as Java class files. Many Java class files are downloaded from the Internet for execution on a user's computer system.

One of the first steps performed by a JVM when executing an application is called verification. A class file verifier, which is part of the JVM, ensures that the file truly is a Java class file and will execute without violating any Java security restrictions. The verifier also checks various sections of the class file for consistency. During the linking phase, the verifier ensures that all classes except for the “Object” class have a superclass and that all field and method references in the constant pool have valid names, classes, and type descriptors. In addition, the verifier checks the code array of the code attribute for each method to ensure that all local variables contain values of the appropriate type, that methods are called with the appropriate arguments, and that fields are assigned correct values. The verifier also checks the operand stack for correctness.

Finally, during execution, the verifier checks to ensure that a referenced type is allowed for instructions referencing a type. If an instruction modifies a field or calls a method, the verifier checks to ensure that the field or method is available and that the calling method is allowed to access the field or call the method. The present invention operates within a standard JVM without disturbing the operations of the JVM's class file verifier.

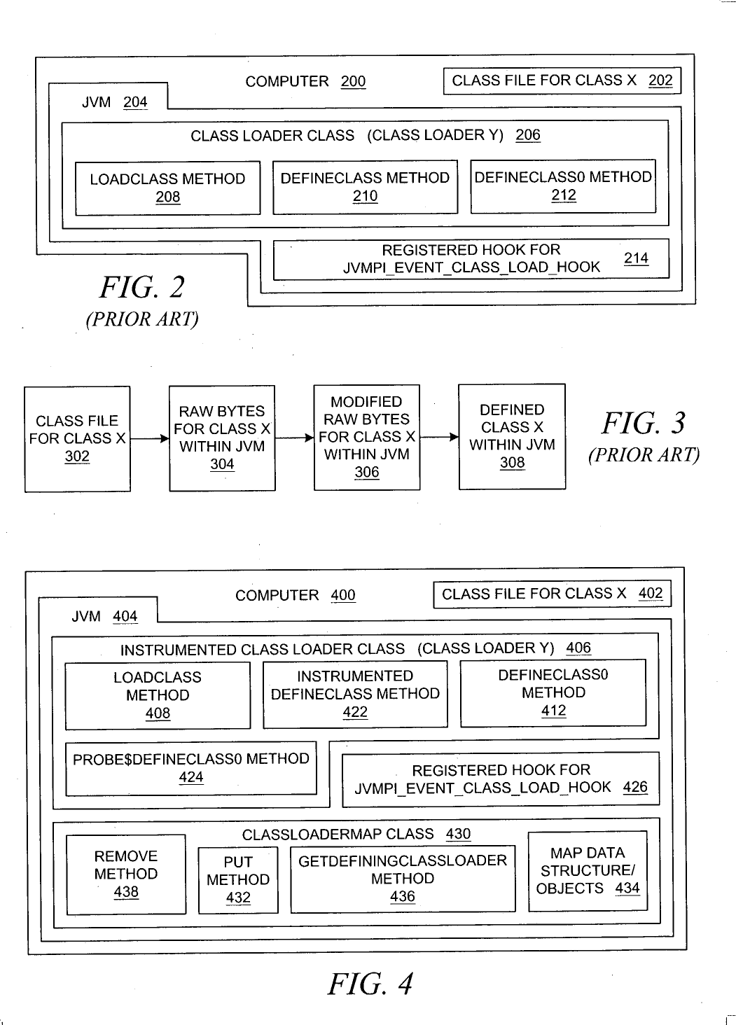

With reference now to FIG. 2, a block diagram depicts a typical JVM for illustrating some of the typical components for loading and defining a Java class. Computer 200 stores Java class file 202 for Java class “X”. JVM 204 supports ClassLoader class “Y” 206, which comprises many methods for loading and defining classes, including “loadClass” method 208, “defineClass” method 210, and native method “defineClass0” 212; the use of these methods are discussed in more detail further below. After the raw bytes for class “X” have been loaded but before class “X” has been formally defined, JVM 204 invokes any hooks that have been registered for class load events, e.g., a registered JVMPI class load hook 214 for events of type “JVMPI_EVENT_CLASS_LOAD_HOOK”. The invocation of a hook at that time allows the raw bytes of class “X” to be modified, e.g., for software instrumentation purposes. Class “X” is subsequently defined in a formal manner, after which the JVM's class file verifier can determine whether class “X” meets certain conditions.

With reference now to FIG. 3, a data flow diagram depicts a typical progression of a dataset representing a class as it passes through a series of processing stages. Class file 302 represents a class “X”; class file 302 contains compiled bytes codes for class “X”. The class file may be retrieved either from a local datastore or from a remote data repository. The raw bytes for class “X” 304 are loaded from the class file into an appropriate location within the JVM that is preparing class “X” for use. The JVM then allows programmatic entities to modify the raw bytes for class “X” through the use of the registered JVMPI class load hook to produce modified raw bytes for class “X” 306; for example, the modified raw bytes may represent an instrumented version of class “X”. The JVM eventually formally defines class “X” 308 using the modified raw bytes; at this point, methods within the defined class “X” may be invoked as necessary.

Given the description of FIGS. 1A-3 as background information, the description of the remaining figures relates to the present invention, which is directed to a method for determining a defining ClassLoader for a Java class as it is being defined. Although a class that is processed in accordance with the present invention follows processing stages that are similar to those that are shown in FIG. 3, the present invention provides enhanced capabilities for producing the modified raw bytes. In other words, the present invention provides a mechanism for possessing more information at stage 306 so that certain operations might be performed at stage 306 than would otherwise not be possible in a typical JVM.

As noted above, in a typical JVM environment, a programmer that is attempting to use the JVMPI class load hook along with knowledge of a defining ClassLoader is faced with a timing problem. Knowledge of the defining ClassLoader for a Java class can provide important contextual information about the class, and this contextual information could be useful during operations which are invoked through the JVMPI class load hook. However, in a typical JVM, the defining ClassLoader cannot be determined until some time after the JVMPI class load hook is invoked.

The present invention solves the above stated problem by instrumenting the “java.lang.ClassLoader” class. The present invention employs the fact that, within a JVM, all ClassLoader instances must call one of the (protected final) “defineClass” methods of class “java.lang.ClassLoader” in order to pass the raw bytes for a class to the JVM to have it defined as a Java class. Therefore, instrumentation code is inserted into the “defineClass” methods of “java.lang.ClassLoader”; the instrumentation code allows all class definition events to be examined prior to the invocation of the JVMPI class load hook by the JVM, as described in more detail further below.

With reference now to FIG. 4, a block diagram depicts a modified JVM that has been enhanced for performing additional operations during the loading and defining of a Java class. FIG. 4 is similar to FIG. 2. Computer 400 stores Java class file 402 for Java class “X”. JVM 404 supports ClassLoaders and allows for the registration of hooks for particular events, including a JVMPI class load hook.

FIG. 4. differs from FIG. 2 in some respects, though; it should be noted that additional differences may be present in an implementation of the present invention that are not shown in FIG. 4. JVM 404 supports instrumented ClassLoader class “Y” 406, which is similar to ClassLoader class “Y” 206 in FIG. 2; instrumented ClassLoader class “Y” 406 comprises many methods for loading and defining classes, including “loadClass” method 408 and native method “defineClass0” 412. However, instrumented ClassLoader class “Y” 406 differs from ClassLoader class “Y” 206 in FIG. 2 in that each of the “defineClass” methods in ClassLoader class “Y” 406 have been instrumented, one of which is shown as instrumented “defineClass” method 422, which itself invokes “probe$defineClass0” method 424; these methods are described in more detail further below.

In a manner similar to that described above for FIG. 2, after the raw bytes for class “X” have been loaded but before class “X” has been formally defined, JVM 404 invokes any hooks that have been registered for class load events, e.g., registered JVMPI class load hook 426. The invocation of a hook at that time allows the raw bytes of class “X” to be modified, e.g., for software instrumentation purposes.

An important distinction between FIG. 2 and FIG. 4, though, is that with the present invention, as shown in the example implementation in FIG. 4, registered JVMPI class load hook 426 has the ability to identify ClassLoader “Y” as the ClassLoader that has been employed by the JVM for class “X”. Since this context information is not available to registered JVMPI class load hook 214 in JVM 204, registered JVMPI class load hook 426 in JVM 404 is able to perform additional operations that are not possible for JVMPI class load hook 214 in JVM 204 without this context information.

“ClassLoaderMap” class 430 assists in the identification of ClassLoader “Y” as the ClassLoader that has been employed by the JVM for class “X”. “ClassLoaderMap” class 430 comprises several methods that are invoked to manage this information; it should be noted that additional methods and interfaces may be present in an implementation of the present invention that are not shown in FIG. 4. Method “put” 432 stores a mapping from a loaded class name to its ClassLoader object, i.e. an association between a loaded class name and its ClassLoader, in an appropriate data structure or set of objects 434. Method “getDefiningClassLoader” 436 retrieves the ClassLoader and method “remove” 438 deletes an entry from the data structure or set of objects. These methods are described in more detail further hereinbelow.

In one embodiment of the present invention, a new “ClassLoaderMap” class is created that maintains a mapping of a Java class name to its defining ClassLoader instance. The “ClassLoaderMap” class contains the interface methods that are shown in TABLE 1.

TABLE 1
public static void put(String className, Object classLoader);
public static ClassLoader getDefiningClassLoader(String className);
public static void remove(String className);

The “ClassLoaderMap” class needs to maintain a mapping of a Java class name to its associated defining ClassLoader and cannot simply save the most recent ClassLoader passed to the put method because the process of defining a class can itself trigger the need for another class to be loaded. Such is the case when the JVM tries to load a class before its superclass or superinterfaces have been loaded. The process of defining the class causes the JVM to load and define its superclass and superinterfaces before the class itself can be successfully defined.

The mapping of a Java class name to its associated defining ClassLoader may be maintained in a table or other data structure. The “ClassLoaderMap.put” method stores an association between a Java class name and its defining ClassLoader in an appropriate data structure. The “ClassLoaderMap.remove” method deletes an association between a Java class name and its defining ClassLoader. The “ClassLoaderMap.getDefiningClassLoader” method retrieves an association between a Java class name and its associated defining ClassLoader from the appropriate data structure.

Since each of the “defineClass” methods of the “java.lang.ClassLoader” class in turn eventually invokes a native “defineClass0” method in the “java.lang.ClassLoader” class, an embodiment of the present invention modifies the invocation of the “defineClass0” method by each of the “defineClass” methods of the “java.lang.ClassLoader” class. A typical initial definition for a “defineClass” method is shown in TABLE 2.

TABLE 2

```
protected final Class defineClass(String className, ...)
{
  /* original code of the defineClass method part 1 */
  ...
  Class result = defineClass0(className, ...);
  /* original code of the defineClass method part 2 */
  ...
  return result;
}
```

Given the typical initial definition for a “defineClass” method as shown in TABLE 2, the present invention instruments each of the “defineClass” methods of the “java.lang.ClassLoader” class as shown in TABLE 3.

TABLE 3

```
protected final Class defineClass(String className, ...)
{
  /* original code of the defineClass method part 1 */
  ...
  Class result = probe$defineClass0(className, ...);
  /* original code of the defineClass method part 2 */
  ...
  return result;
}
```

In this embodiment, the “defineClass” method is simply modified to invoke a method called “probe$defineClass0” instead of “defineClass0”. The “probe$defineClass0” method is then added to the “java.lang.ClassLoader” class; TABLE 4 contains an example of code that is included within the “probe$defineClass0” method of the described embodiment of the present invention.

TABLE 4

```
private Class probe$defineClass0(String className, ...)
{
  ClassLoaderMap.put(className, this);
  Class result = defineClass0(className, ...);
  ClassLoaderMap.remove(className);
  return result;
}
```

Referring to TABLE 4, prior to executing the original “defineClass0” method, the “ClassLoaderMap” class is called; the call to the “ClassLoaderMap.put” method saves the ClassLoader instance (given by the “this” Object) as the defining ClassLoader of the class that is identified by the “className” String.

Subsequently, the original “defineClass0” method is executed. The execution of the original “defineClass0” method will in turn invoke a registered JVMPI class load hook to allow this class to be modified. Hence, information about the defining ClassLoader for the class being defined is available within the execution of the hook; the defining ClassLoader can be retrieved by invoking the “ClassLoaderMap.getDefiningClassLoader” method.

Following the execution of the original “defineClass0” method, the “ClassLoaderMap” class is again called to remove the data structure entry for the class being defined; the defining ClassLoader is deleted by invoking the “ClassLoaderMap.remove” method. After the class has been defined, its defining ClassLoader can be retrieved via a simple sequence of Java API calls, so it is no longer necessary to maintain this information in the “ClassLoaderMap” class.

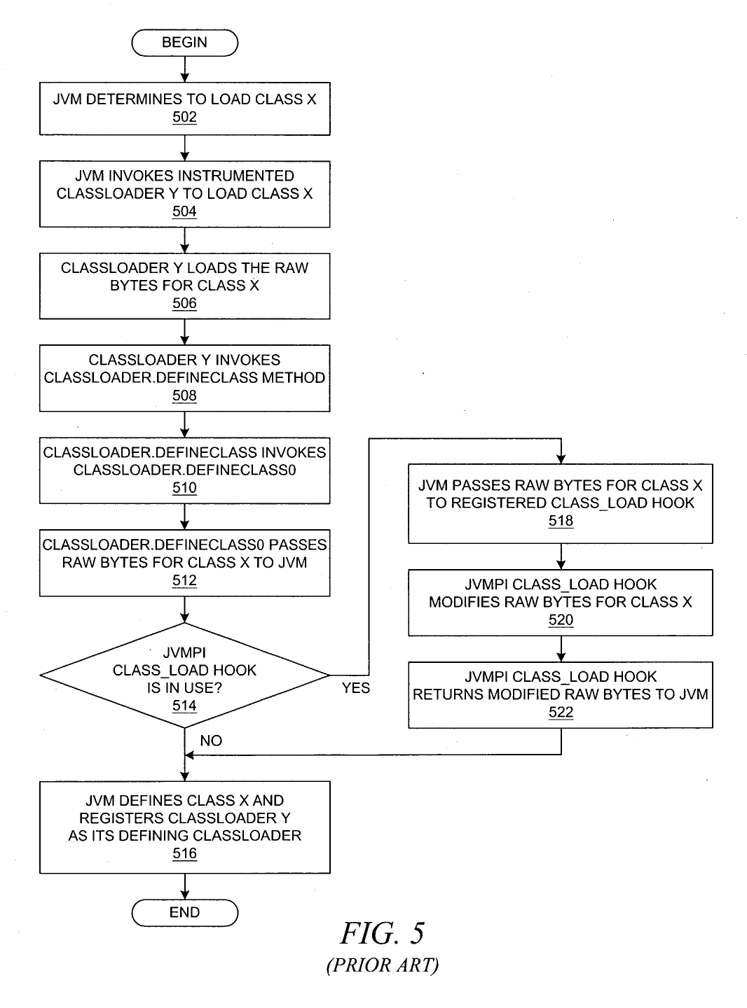

With reference now to FIG. 5, a flowchart depicts a process within a typical JVM for using, a JVMPI class load hook to modify the raw bytes of a recently loaded class before the class is formally defined by the JVM. The process begins when a typical JVM determines to load a particular class, shown as class “X” in this example (step 502). The JVM invokes a ClassLoader, shown as ClassLoader “Y” in this example (step 504). ClassLoader “Y” obtains and loads the raw bytes for class “X”, e.g., from an appropriate class file (step 506).

ClassLoader “Y” then invokes the appropriate “defineClass” method within the ClassLoader class (step 508), and the “defineClass” method invokes the native method “defineClass0” method (step 510), as shown above in TABLE 2. The “ClassLoader.defineClass0” method then passes the raw bytes for class “X” to the JVM (step 512).

The JVM then determines if the JVMPI class load hook is in use (step 514), and if not, then the JVM defines class “X” and registers ClassLoader “Y” as its defining ClassLoader (step 516), and the process is complete. If the JVMPI class load hook is determined to be in use at step 514, then the JVM passes the raw bytes for class “X” to the registered class load hook (step 518). In other words, the JVM invokes the previously registered class load hook, which is provided access to the raw bytes for class “X”. The executing class load hook then modifies the raw bytes of class “X” (step 520); the class load hook then returns control to the JVM (step 522), which uses the modified raw bytes to define class “X”, and the process is complete.

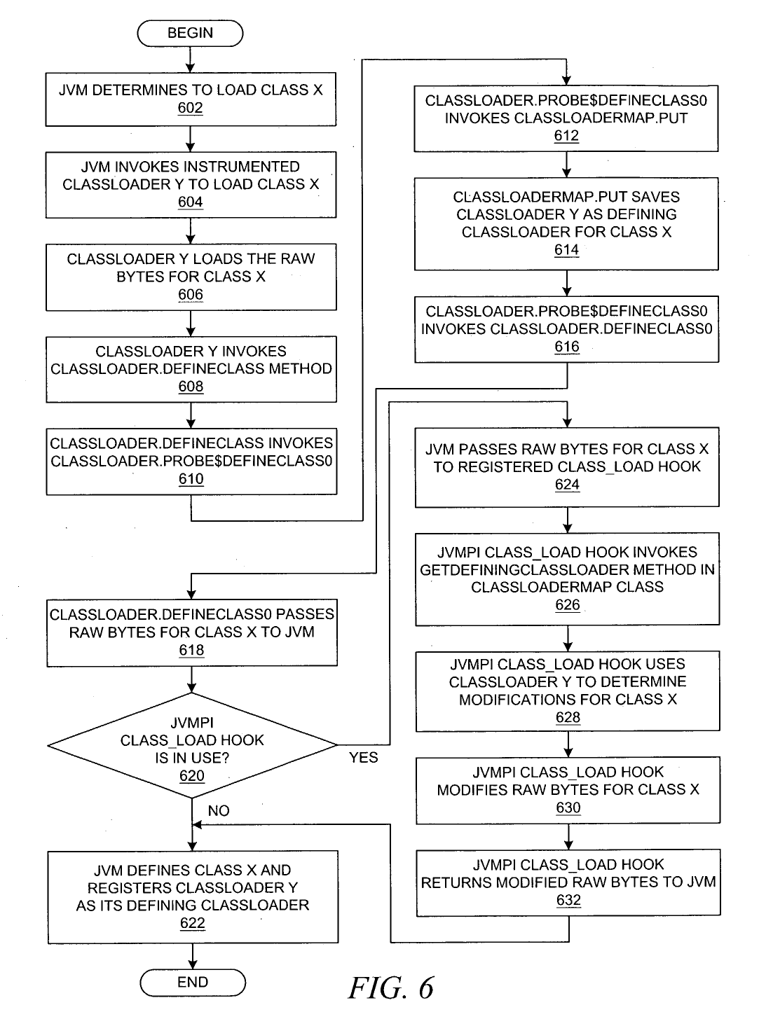

With reference now to FIG. 6, a flowchart depicts a process within a JVM that has been instrumented in accordance with the present invention in order to obtain the defining ClassLoader for a recently loaded class such that the raw bytes of the recently loaded class can be modified by a JVMPI class load hook with reference to information about the defining ClassLoader. The process that is shown in FIG. 6 is similar to the process that is shown in FIG. 5 except that additional steps are shown in FIG. 6 in accordance with an embodiment of the present invention.

The process begins when a JVM that has been instrumented in accordance with the present invention determines to load a particular class, shown as class “X” in this example (step 602). The JVM invokes an instrumented ClassLoader, shown as ClassLoader “Y” in this example (step 604). ClassLoader “Y” obtains and loads the raw bytes for class “X”, e.g., from an appropriate class file (step 606).

ClassLoader “Y” then invokes the appropriate “defineClass” method within the ClassLoader class (step 608). In contrast to the example shown in the flowchart of FIG. 5, since ClassLoader “Y” in the example shown in FIG. 6 has been instrumented in accordance with the present invention, the “defineClass” method invokes the “probe$defineClass0” method (step 610), as shown above in TABLE 3. The “ClassLoader.probe$defineClass0” method invokes the “ClassLoaderMap.put” method (step 612), which saves the identity of ClassLoader “Y” as the defining ClassLoader for class “X” in an appropriate data structure (step 614). The “ClassLoader.probe$defineClass0” method then invokes the “ClassLoader.defineClass0” method (step 616). In a manner similar to step 512 in FIG. 5, the “ClassLoader.defineClass0” method then passes the raw bytes for class “X” to the JVM (step 618). In this manner, the invocation of the “ClassLoader.defineClass0” method by the “ClassLoader.defineClass” method has been replaced with a call to the “ClassLoader.probe$defineClass0” method, which enables the identity of ClassLoader “Y” to be saved as the defining ClassLoader for class “X” prior to the “defineClass0” method notifying the JVM that the raw bytes for class “X” are ready for further processing.

In a manner similar to steps 514 and 516 in FIG. 5, the process that is shown in FIG. 6 continues with the JVM determining if the JVMPI class load hook is in use (step 620), and if not, then the JVM defines class “X” and registers ClassLoader “Y” as its defining ClassLoader (step 622), and the process is complete. If the JVMPI class load hook is determined to be in use at step 620, then the JVM passes the raw bytes for class “X” to the registered class load hook (step 624). In other words, the JVM invokes the previously registered class load hook, which is provided access to the raw bytes for class “X”.

At this point, the process that is shown in FIG. 6 again diverges from the process that is shown in FIG. 5. In a JVM that has been modified in accordance with the present invention, the JVMPI class load hook can obtain the defining ClassLoader for class “X” by calling the “ClassLoaderMap.getDefiningClassLoader” method (step 626). The executing class load hook then uses the identity of the defining ClassLoader to assist in determining the proper modifications that should be made for the raw bytes of class “X” (step 628), after which the modifications are made (step 630). The class load hook then returns control to the JVM (step 632), which uses the modified raw bytes to define class “X”, and the process is complete. It should be noted that a similar control flow occurs on the return path of the method invocation stack to remove the entry from the “ClassLoaderMap” class objects or data structures via a call to the “ClassLoaderMap.remove” method, which is not shown in FIG. 6.

It should be noted that the “ClassLoaderMap” class maintains its mapping of a Java class name String to its defining ClassLoader on a per thread basis. Hence, if two classes with the same name are concurrently being defined by two different ClassLoaders, the ClassLoaderMap will be able to properly resolve the defining ClassLoader for the desired class. In this case, the “ClassLoaderMap.getDefiningClassLoader” method must be called by the same thread that invoked the “ClassLoaderMap.put” method, which is not a problem as the entire process is serialized.

The present invention is also applicable to similar modifications on the “java.lang.reflect.Proxy” class. The “java.lang.reflect.Proxy” class allows for the dynamic generation of a proxy class within the JVM. The “java.lang.reflect.Proxy” class defines these proxy classes directly to the JVM through its own “defineClass0” method rather than using the “java.lang.ClassLoader.defineClass0” method. In order to ensure that the defining ClassLoader for proxy classes can be determined, the “java.lang.reflect.Proxy” class would be instrumented as well.

The advantages of the present invention should be apparent in view of the detailed description of the invention that is provided above. The present invention provides contextual information about the defining ClassLoader of a class that is actively being defined by the JVM. Using this information, a programmatic entity, such as a routine that has been invoked as a registered JVMPI class load hook, can examine the superclass and the superinterfaces of the class that is being defined in order to understand its inheritance hierarchy. The inheritance hierarchy of a class can then be used in some manner, e.g., to determine whether and/or how the class that is being defined should be instrumented.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for processing information, the method comprising:
storing an identity of a class loader class that loads a class into a virtual machine;
invoking a class load hook routine after the identity of the class loader class has been stored; and
retrieving the stored identity of the class loader class in response to invoking the class load hook routine.

2. The method of claim 1 further comprising:
using the stored identity of the class loader class to modify information associated with the class before the class is defined by the virtual machine.

3. The method of claim 2 further comprising:
modifying class bytes for the class.

4. The method of claim 3 further comprising:
instrumenting the class.

5. The method of claim 2 further comprising:
defining the class by the virtual machine after information associated with the class is modified.

6. The method of claim 1 wherein the storing step and the invoking step are performed before the class is defined by the virtual machine.

7. The method of claim 1 wherein the storing step further comprises:
invoking an instrumented method within the class loader class, wherein the instrumented method is a “defineClass” method for the class loader class; and
saving the identity of the class loader class within an instrumented version of a native “defineClass0” method.

8. A computer program product in a computer readable machine for use in a data processing system for processing information, the computer program product comprising:
means for storing an identity of a class loader class that loads a class into a virtual machine;
means for invoking a class load hook routine after the identity of the class loader class has been stored; and
means for retrieving the stored identity of the class loader class in response to invoking the class load hook routine.

9. The computer program product of claim 8 further comprising:
means for using the stored identity of the class loader class to modify information associated with the class before the class is defined by the virtual machine.

10. The computer program product of claim 9 further comprising:
means for modifying class bytes for the class.

11. The computer program product of claim 10 further comprising:
means for instrumenting the class.

12. The computer program product of claim 9 further comprising:
means for defining the class by the virtual machine after information associated with the class is modified.

13. The computer program product of claim 8 wherein the storing means and the invoking means are executed before the class is defined by the virtual machine.

14. The computer program product of claim 8 wherein the storing means further comprises:
means for invoking an instrumented method within the class loader class, wherein the instrumented method is a “defineClass” method for the class loader class; and
means for saving the identity of the class loader class within an instrumented version of a native “defineClass0” method.

15. An apparatus for processing information, the apparatus comprising:
means for storing an identity of a class loader class that loads a class into a virtual machine;
means for invoking a class load hook routine after the identity of the class loader class has been stored; and
means for retrieving the stored identity of the class loader class in response to invoking the class load hook routine.

16. The apparatus of claim 15 further comprising:
means for using the stored identity of the class loader class to modify information associated with the class before the class is defined by the virtual machine.

17. The apparatus of claim 16 further comprising:
means for modifying class bytes for the class.

18. The apparatus of claim 17 further comprising:
means for instrumenting the class.

19. The apparatus of claim 16 further comprising:
means for defining the class by the virtual machine after information associated with the class is modified.

20. The apparatus of claim 15 wherein the storing means and the invoking means are executed before the class is defined by the virtual machine.

21. The apparatus of claim 15 wherein the storing means further comprises:
means for invoking an instrumented method within the class loader class, wherein the instrumented method is a “defineClass” method for the class loader class; and
means for saving the identity of the class loader class within an instrumented version of a native “defineClass0” method.
